(19) United States
(12) Patent Application Publication
(10) Pub. No.: US 2021/0101530 A1
(43) Pub. Date: Apr. 8, 2021

(54) Transportation Information Display Device

(71) Applicant: TaiLai TING, Pomona, CA (US)

(72) Inventor: TaiLai TING, Pomona, CA (US)

(21) Appl. No.: 16/591,628

(22) Filed: Oct. 3, 2019

(51) Int. Cl. B60R 1/00; B60K 35/00; G02B 27/01

(52) U.S. Cl. CPC B60R 1/00; B60K 35/00; G02B 27/017; B60Y 2200/12; G02B 2027/0178; B60R 2300/302; B60Y 2400/303; B60Y 2400/301

(57) ABSTRACT

A transportation information display device for a vehicle includes a GPS speedometer adapted for measuring a speed of the vehicle in response to a GPS data to generate a current speed of the vehicle, a display unit for displaying the current speed of the vehicle from the GPS speedometer; and a data transmission link operatively linking between the GPS speedometer and the display unit, wherein a distance between the GPS speedometer and the display unit is adjustable and extendable via the data transmission link, such that the display unit is selectively supported at a desired location for providing a visualization of the current speed of the vehicle into a visual field of a driver within the driver's line of sight without requiring the driver to remove said visual field away from the road.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to driving information display, and more particularly to a transportation information display device that is able to be accurately displayed in the driver's field of vision while driving.

### Description of Related Arts

Taking your eyes off the road for a split second is all it takes to get into a vehicular accident, and this is especially true the faster the vehicle is traveling. Studies have shown that a fairly average reaction time for a human is approximately 0.75 seconds, and more often than not this reaction time can be more than this average due to external factors such as personal characteristics, alertness, and visual acuity. This 0.75 seconds may sound like very little but in combination with application of the brakes of a vehicle as well as the stopping distance required at certain speeds, even a driver following proper driving safety is still liable to cause an accident. For example, a car traveling at 65 miles per hour will travel approximately 70 feet in the 0.75 seconds during the reactionary processing. Additionally, it takes about 0.3 seconds to apply the brake, during which the car will travel approximately another 28 feet. And the stopping distance for a car under the best road conditions traveling at that speed is approximately 188 feet. So this means that under nearly ideal conditions an alert driver can avoid hitting obstacles that are no less than 300 feet away. When you add in various other external distractions, even a driver abiding by the 2-second distance rule is likely to encounter a vehicle collision. And this is especially true for motorcyclists, where high speed accidents are generally more fatal, or even regular cyclists where collisions are likely to throw a ride off their vehicle.

With the modernization of these types of vehicles the amount of information present to the user has also increased. Various readouts and gauges relating to performance communicate information to the user that can be vital to the vehicular experience. For example, a speedometer is generally located on a dashboard, or in an area that requires the user to tilt their head or almost completely shift their vision from the road to view the speedometer. The instrument placement on vehicles makes it hard for the user to focus on the speedometer, process the information, and then focus back on the road quickly. When the user has to temporarily remove their vision from the road or even physically reorient their head to see this information of the speedometer, the likely hood of getting into a vehicular collision is increased. If the user was able to get this driving information without having to take their eyes away from the road a much more enjoyable riding experience could be achieved.

Generally speaking, the speedometer is a gauge to measure and display a speed of a vehicle. However, the speedometer cannot measure the true speed of the vehicle because the speedometer actually measures the rotational speed of the vehicle wheel and converts it into the linear speed of the vehicle. In other words, when the tire pressure is reduced or the tire is physically worn down over time, the rotational speed of the vehicle is changed to reduce the accuracy of the speedometer. Especially for cyclists, the true speed of the vehicle will let the cyclists to get better efficiency and speed at the lower gears and to maximize the performance especially during cornering.

Furthermore, current devices exist that mount battery powered devices onto a user's helmet to display the driving information, but these devices provide many disadvantages. One of the largest disadvantages is that since the device mounts onto the user's helmet to display the driving information, it is highly likely to obscure the user's vision and create confusion with real world objects. Additionally, the user is unable to turn it off while operating the motorcycle as a hand would have to be taken off the steering mechanism to do such since it is always activated. Similarly, if the device becomes dislodged or disoriented during operation it can be very dangerous for the user to re-orientate the device while operating the motorcycle.

### SUMMARY OF THE PRESENT INVENTION

The invention is advantageous in that it provides a transportation information display, which comprises a GPS speedometer for measuring a speed of the vehicle in response to a GPS data so as to accurately display the vehicle speed.

Another advantage of the invention is to provide a transportation information display, wherein a distance between the GPS speedometer and the display unit is adjustable and extendable, such that the display unit is adapted for providing a visualization of the current speed of the vehicle into a visual field of a driver within the driver's line of sight without requiring the driver to remove the visual field away from the road.

Another advantage of the invention is to provide a transportation information display, which can employ in different articles, such as car, motorcycle, helmet, headgear, wrist gear, eye gear, without altering the original structure of the articles.

Another advantage of the invention is to provide a transportation information display, which can generate a speed warning signal on the display unit in response to the GPS data.

Another advantage of the invention is to provide a transportation information display, wherein the speed limit can be manually set to bypass the speed limit preset in the GPS data.

Another advantage of the invention is to provide a transportation information display, wherein the operation of the transportation information display is easy by simply locating the display unit within the driver's line of sight.

Another advantage of the invention is to provide a transportation information display, which does not involve complicated and expensive mechanical and/or electrical components and processes so that the manufacturing cost of the present invention can be minimized.

Another advantage of the invention is to provide a transportation information display, wherein no expensive or complicated structure is required to employ in the present invention in order to achieve the above mentioned objects. Therefore, the present invention successfully provides an economic and efficient solution for two different nail care configuration for nail surface treatment. For example, the present invention provides a handy information display device for accurately displaying the current speed of the vehicle within the driver's line of sight.

Additional advantages and features of the invention will become apparent from the description which follows, and may be realized by means of the instrumentalities and combinations particular point out in the appended claims.

According to the present invention, the foregoing and other objects and advantages are attained by a transportation information display device for a vehicle, comprising:

a GPS speedometer adapted for measuring a speed of the vehicle in response to a GPS data to generate a current speed of the vehicle;

a display unit adapted for displaying the current speed of the vehicle from the GPS speedometer; and

a data transmission link operatively linking between the GPS speedometer and the display unit, wherein a distance between the GPS speedometer and the display unit is adjustable and extendable via the data transmission link, such that the display unit is selectively supported at a desired location for providing a visualization of the current speed of the vehicle into a visual field of a driver within the driver's line of sight without requiring the driver to remove the visual field away from the road.

In accordance with another aspect of the invention, the present invention comprises a method of providing a current speed of a vehicle, comprising the steps of:

(a) placing a GPS speedometer at a desired location of a vehicle;

(b) collecting a GPS data by the GPS speedometer to generate a current speed signal of the vehicle;

(c) operatively linking the GPS speedometer and a display unit via a data transmission link that a distance between the GPS speedometer and the display unit is adjustable and extendable via the data transmission link;

(d) placing the display unit at a position within a driver's line of sight; and

(e) displaying the current speed signal of the vehicle by the display unit for providing a visualization of the current speed of the vehicle into a visual field of a driver within the driver's line of sight without requiring the driver to remove the visual field away from the road.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a transportation information display device according to a preferred embodiment of the present invention.

FIG. 2 illustrates the transportation information display device being employed in a motorcycle according to the above preferred embodiment of the present invention.

FIG. 3 illustrates the transportation information display device being employed in a helmet according to the above preferred embodiment of the present invention.

FIG. 4 illustrates an alternative mode of the transportation information display device being employed in the helmet according to the above preferred embodiment of the present invention.

FIG. 5 illustrates the transportation information display device being employed in a car according to the above preferred embodiment of the present invention.

FIG. 6 illustrates the transportation information display device being employed in a headgear according to the above preferred embodiment of the present invention.

FIG. 7 illustrates the transportation information display device being employed in a wrist gear according to the above preferred embodiment of the present invention.

FIG. 8 illustrates the transportation information display device being employed in a first eye gear according to the above preferred embodiment of the present invention.

FIG. 9 illustrates the transportation information display device being employed in a second eye gear according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

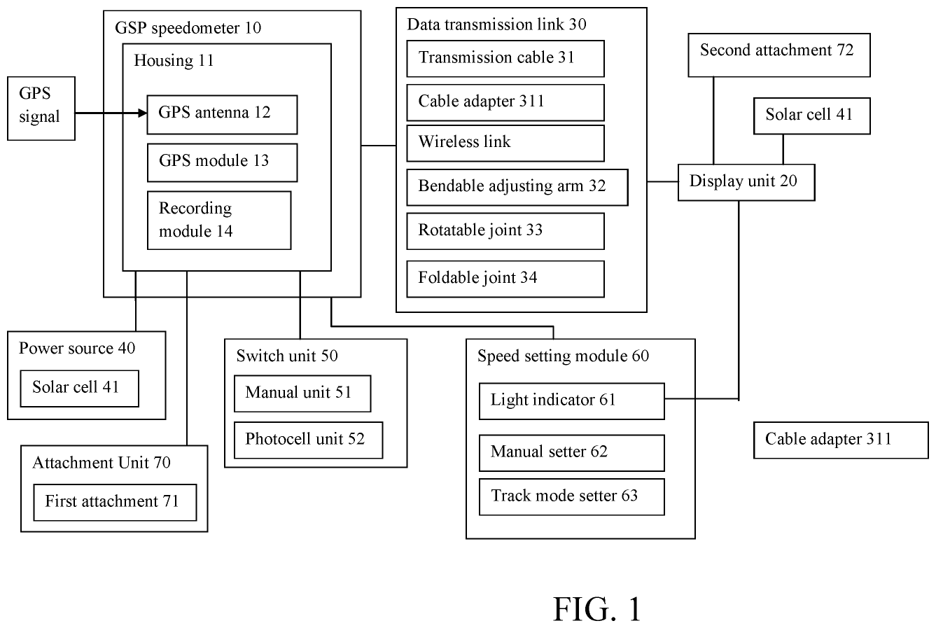

Referring to FIG. 1 of the drawings, a transportation information display according to a preferred embodiment of the present invention, wherein the transportation information display comprises a GPS speedometer 10, a display unit 20, and a data transmission link 30.

In one embodiment, the transportation information display device of the preset invention is employed for a vehicle. Accordingly, the GPS speedometer 10 is adapted for measuring a speed of the vehicle in response to a GPS data to generate a current speed signal of the vehicle. The display unit 20 is adapted for displaying a current speed of the vehicle from the GPS speedometer 10. The data transmission link 30 is operatively linking between the GPS speedometer 10 and the display unit 20, wherein a distance between the GPS speedometer 10 and the display unit 20 is adjustable and extendable via the data transmission link 30. Therefore, the display unit 20 is selectively supported at a desired location for providing a visualization of the current speed of the vehicle into a visual field of a driver within the driver's line of sight without requiring the driver to remove the visual field away from the road.

According to the preferred embodiment, the GPS speedometer 10 comprises a housing 11, a GPS antenna 12 for receiving the GPS signal, and a GPS module 13 received in the housing 11 for converting the GPS signal into the GPS data to be displayed on the display unit 20. It is worth mentioning that when the GPS speedometer 10 is placed in the vehicle, the current speed of the GPS speedometer 10 is the same as the current speed of the vehicle. The speed measurement of the vehicle can be obtained by the GPS speedometer 10. Furthermore, the GPS module 13 serves as a circuit to convert the GPS data into the current speed signal of the vehicle. In other words, the GPS signal contains the location data of the vehicle, the current speed signal of the vehicle to accurately determine the speed vehicle and the speed limit data in response to the current location of the vehicle. In one embodiment, the GPS speedometer 10 comprises a recording module 14 recording the current speed of the vehicle in response to the GPS data within a predetermined time interval and saving it in a memory.

The display unit 20 is preferably embodied as a digital screen, such as LED screen, LCD screen, OLED screen, or E-Ink display, to digitally display the current speed signal of the vehicle when the current speed signal of the vehicle is sent from the GPS module 13 to the display unit 20, wherein the display unit 20 is a low-power consumption device to minimize the energy consumption during the operation. Accordingly, the size of the display unit 20 can be designed to have a 1 cm length and 1.5 cm width, wherein the display unit 20 can be selectively placed within the driver's line of sight with a distance of 4 cm±0.5 cm from one eye of the driver. It is worth mentioning that one eye of the driver is considered as a dominant eye and another eye of the driver is considered as a non-dominant eye. The display unit 20 is preferably placed within the driver's line of sight at the non-dominant eye thereof. In other words, the display unit 20 should not be placed at the centerline of the eyes of the driver which may block the view of the driver. Accordingly, the display unit 20 comprises a flexible screen film, wherein the display unit 20 is bendable to affix on a non-flat surface. Alternatively, the display unit 20 comprises a rigid screen film, wherein the display unit 20 is non-bendable to affix on a flat surface.

The transportation information display device further comprises an attachment unit 70 provided on at least one of the GPS speedometer 10 and the display unit 20, such that the GPS speedometer 10 and the display unit 20 can be selectively placed at different locations.

The data transmission link 30 comprises at least a transmission cable 31 electrically connect the GPS speedometer 10 to the display unit 20. Accordingly, the distance between the GPS speedometer 10 and the display unit 20 is adjustable by selectively configuring a length of the transmission cable 31, such that the display unit 20 can be selectively located away from the GPS speedometer 10 in a distance manner. The distance between the GPS speedometer 10 and the display unit 20 is extendable by selectively configuring a length of the transmission cable 31. In addition, the distance between the GPS speedometer 10 and the display unit 20 is extendable by selectively connecting two or more of the transmission cables 31 end-to-end via a cable adapter 311, such that the display unit 20 can be selectively located away from the GPS speedometer 10 in a distance manner. The transmission cable 31 is also bendable to selectively adjust the relative orientation between the GPS speedometer 10 and the display unit 20, such that the GPS speedometer 10 and the display unit 20 can be located at different planar directions or different angles. The transmission cable 31 can be supported in a suspend manner, i.e. hanging or dangling in the air, in order to connect the GPS speedometer 10 and the display unit 20 with each other.

Alternatively, the data transmission link 30 is a wireless link, such as Bluetooth connection or RF connection, to wirelessly connect the GPS speedometer 10 with display unit 20, such that the distance between the GPS speedometer 10 and the display unit 20 is adjustable and extendable via wireless connection of the data transmission link 30.

Preferably, the transportation information display device further comprises a power source 40 received in the housing 11 of the GPS speedometer 10 for electrically powering the GPS speedometer 10 and/or the display unit 20. Accordingly, the power source 40 can be a rechargeable battery received in the housing 11 that the power source 40 can be recharged to supply the power to the GPS speedometer 10 and/or the display unit 20. Alternatively, the power source 40 can be a battery compartment formed at the housing 11 for receiving a replaceable battery. In addition, the power source 40 can be a power circuit received in the housing 11 to electrically link to the GPS module 13 for electrically connecting to a power supply of the vehicle via a power cable. It is worth mentioning that since the power source 40 is not provided at the display unit 20, the overall size and weight of the display unit 20 can be minimized.

Accordingly, when the GPS speedometer 10 and the display unit 20 are electrically connected via the transmission cable 31 of the data transmission link 30, the transmission cable 31 not only transmits the current speed signal from the GPS module 13 to the display unit 20 but also transmits the electrical power from the power source 40 at the housing 11 to the display unit 20.

In order to power the display unit 20 when the display unit 20 is wirelessly connected to the GPS speedometer 10, the power source 40 further comprises a solar cell 41 electrically connected to the display unit 20 for converting solar energy into electrical energy for the display unit 20. Preferably, the display unit 20 has a front viewing side to display the current speed and a rear attaching side, wherein the solar cell 41 is provided at the rear attaching side of the display unit 20 as a power supply thereof. Since the display unit 20 is a low power consumption device, the solar cell 41 is able to power up the display unit 20 for the operation thereof. It is worth mentioning that the solar cell 41 can also provide at the housing 11 to electrically connect to the GPS speedometer 10 for converting solar energy into electrical energy for the GPS speedometer 10. In other words, dual solar cells 41 are provided for the GPS speedometer 10 and the display unit 20 respectively when the GPS speedometer 10 and the display unit 20 are connected wirelessly or by the transmission cable 31.

The transportation information display device further comprises a switch unit 50 to selectively control the GPS speedometer 10 in an on-and-off manner. The switch unit 50 is electrically connected to the power source 40 to switch on and off the GPS speedometer 10. In one embodiment, the switch unit 50 comprises a manual switch 51 provided at the housing 11 to electrically connect to the power source 40 so as to manually switch on and off the GPS speedometer 10. In another embodiment, the switch unit 50 comprises a photocell unit 52 provided at the housing 11 to electrically connect to the power source 40 so as to automatically switch on and off the GPS speedometer 10.

The transportation information display device further comprises a speed setting module 60 built-in with the GPS speedometer 10 to operatively link to the display unit 20, wherein the speed setting module 60 is configured to generate a speed warning signal on the display unit 20 in response to the GPS data. Accordingly, the GPS data includes the speed limit data in response to the current location of the vehicle. When the current speed of the vehicle is detected over the speed limit data, the speed warning signal will be generated at the display unit 20 to notify the driver regarding the speeding issue.

In one embodiment, the speed setting module 60 comprises a light indicator 61 provided at the display unit 20 for generating the speed warning signal. The light indicator 61 is provided at the viewing side of the display unit 20 to generate a light signal, such as light flashing or light on” as the speed warning signal. In other words, the light 61 can be a LED light bulb provided at the display unit 20. In another embodiment, the light indicator 61 is integrated with the screen of the display unit 20, wherein the speed warning signal is in form of flashing the display of the current speed on the display unit 20. Therefore, the user is able to notify the speeding issue when the speed display is flashing. It is appreciated that the speed setting module 60 can be constructed to have a sound indicator or other indicators for generating the speed warning signal.

According to the preferred embodiment, the speed setting module 60 further comprises a manual setter 62 operatively connected to the GPS speedometer 10 for manually setting a speed limit to generate the speed warning signal. The driver is able to manually set the speed limit to bypass the preset speed limit from the GPS data. In other words, the speed warning signal will be generated by the light indicator 61 in response to the manual speed limit but not the detected speed limit from the GPS data.

The transportation information display device can be used in a professional racing field, wherein the transportation information display device is able to provide an actuate and live time speed of the vehicle for the driver, such as a racer. The speed setting module 60 comprises a track mode setter 63 to set different speed limits at different road conditions. In one example, the driver is able to set different speed limits at a racetrack. The track mode setter 63 is programmed to (i) determine a track layout of the racetrack in response to the GPS data; (ii) set a maximum speed at each section of the racetrack; and (iii) indicate the maximum speed on the display unit 20 when the GPS speedometer 10 moves at the racetrack.

The track layout of the racetrack can be automatically determined by the location data of the GPS data. The tack layout is defined into a plurality of consecutive sections, such as a first high-speed straight section and first cornering section, that the driver drives the vehicle from one section to another section. At each section, the driver is able to set the maximum speed at each section by the track mode setter 63. For example, the maximum speed of 93 mph is set at the first high-speed straight section and the maximum speed of 47 mph is set at the first cornering section. Therefore, the corresponding maximum speed will be displayed on the display unit 20 when the vehicle (i.e. the GPS speedometer 10) locates at the corresponding section of the racetrack. In one example, the maximum speed is displayed on the display unit 20 corresponding to the location of the vehicle. In another example, the current speed of the vehicle is displayed on the display unit 20 while the speed limit signal (i.e. the maximum speed) is generated by the light indicator 61 when the current speed of the vehicle exceeds the maximum speed manually set by the driver via the track mode setter 63.

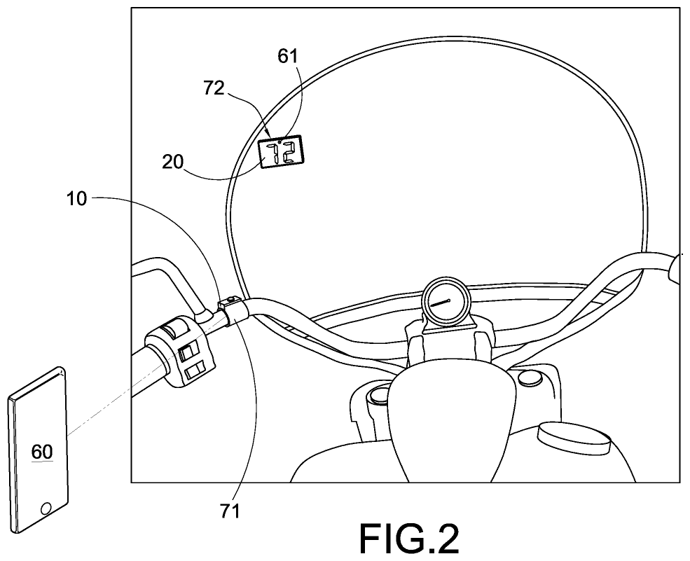

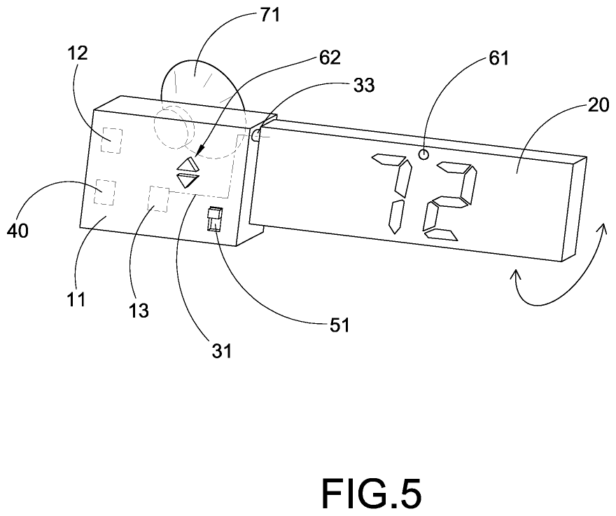

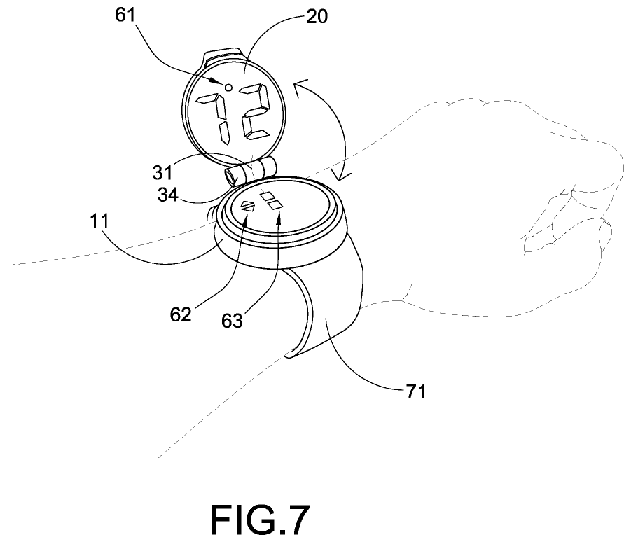

The manual setter 62 and the track mode setter 63 can be implemented as a plurality of actuation buttons, such as press buttons or touch buttons, as shown in FIGS. 5 and 7, such that the driver is able to actuate the actuation buttons for operating the speed setting module 60 so as to control and actuate the GPS speedometer 10. It is worth mentioning that, in one embodiment, the speed setting module 60 is implemented as a software or an application arranged to be downloaded and installed into a portable electronic device, such as a smart phone, as shown in FIG. 2. Therefore, the driver is able to operate the speed setting module 60 to control and actuate the GPS speedometer 10 via the portable electronic device once the GPS speedometer 10 is wirelessly connected (such as through the wireless link) to the portable electronic device.

The transportation information display device can be implemented in different applications. In one example, the transportation information display device is used for a motorcycle as shown in FIG. 2. As shown in FIG. 2, the attachment unit 70 comprises a first attachment 71 provided at the housing 11 for attaching the GPS speedometer 10 at the vehicle, and a second attachment 72 provided at the display unit 20 for attaching the display unit 20 onto a desire location of a windshield of the vehicle. For example, the first attachment 71 can be a detachable clip provided at the housing 11 for detachably clipping at a handbar of the motorcycle. The second attachment 72 can be a self-adhesive film provided at the attaching side of the display unit 20 for adhering the display unit 20 on the windshield surface. Accordingly, the wireless connection is formed between the GPS speedometer 10 and the display unit 20, such that the GPS speedometer 10 and the display unit 20 can be placed at different locations. The solar cell 41 can be provided at the display unit 20 to supply the power thereto.

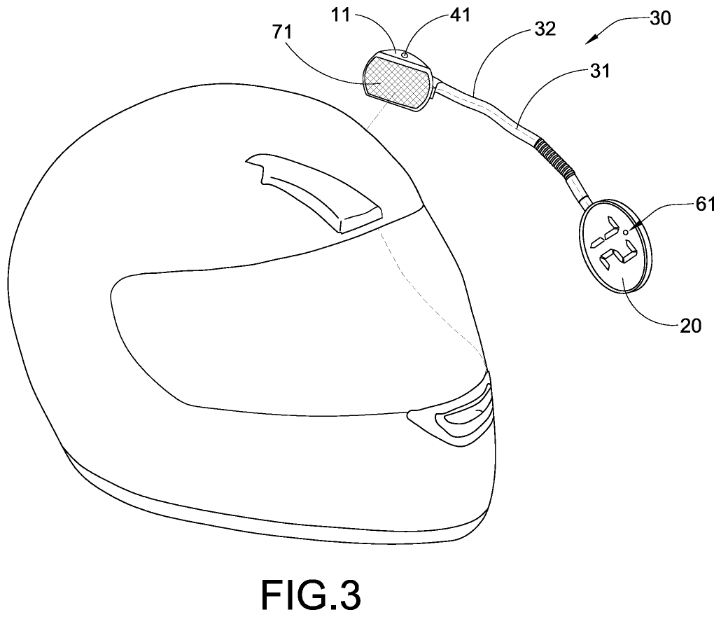

In another example, the transportation information display device is used for a helmet as shown in FIG. 3. As shown in FIG. 3, the data transmission link 30 comprises a bendable adjusting arm 32 having one end connected to the housing 11 of the GPS speedometer 10 and another end connected to the display unit 20, wherein the transmission cable 31 is extended within the bendable adjusting arm 32 to electrically connect the GPS module 13 to the display unit 20.

The first attachment 71 is provided at the housing 11 to attach the housing 11 on the helmet. Preferably, the first attachment 71 can be a self-adhesive film provided at the housing to adhere the housing 11 on the helmet surface, wherein the bendable adjusting arm 32 can be selectively bent to adjust the position of the display unit 20 so as to selectively adjust a viewing angle of the display unit 20. Accordingly, the power source 40 is received in the housing 11 to electrically power the display unit 20 via the transmission cable 31.

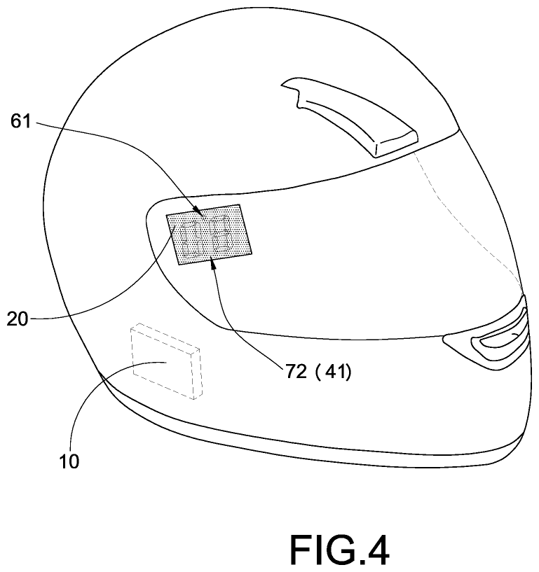

Alternatively, as shown in FIG. 4, the GPS speedometer 10 can be embedded and received in the interior of the helmet. The second attachment 72 can be a self-adhesive film provided at the attaching side of the display unit 20 for adhering the display unit 20 on the face shield of the helmet. Accordingly, the wireless connection is formed between the GPS speedometer 10 and the display unit 20, such that the GPS speedometer 10 and the display unit 20 can be placed at different locations. The solar cell 41 can be provided at the display unit 20 to supply the power thereto. Preferably, the display unit 20 comprises a flexible screen film for displaying the current speed of the vehicle, wherein the self-adhesive film is provided at the flexible screen film for adhering the flexible screen film on inner surface of a spectacle lens.

In another example, the transportation information display device is used for a car as shown in FIG. 5. As shown in FIG. 5, the data transmission link 30 comprises a rotatable joint 33 rotatably coupling the display unit 20 at the housing 11 of the GPS speedometer 10, such that when the GPS speedometer 10 is stationary fixed at a desire location, the display unit 20 is rotated to selectively adjust the viewing angle thereof. In one embodiment, the GPS speedometer 10 and the display unit 20 is coupled side-by-side via the rotatable joint 33, wherein the transmission cable 31 is extended through the rotatable joint 33 to electrically connect the GPS module 13 to the display unit 20.

The first attachment 71 is provided at the housing 11 to attach the housing 11 on the windshield of the car. Preferably, the first attachment 71 can be a suction cup provided at the housing 11 to adhere the housing 11 on the windshield surface, wherein the display unit 20 is selectively rotated to adjust the position of the display unit 20 so as to selectively adjust a viewing angle of the display unit 20. Accordingly, the power source 40 is received in the housing 11 to electrically power the display unit 20 via the transmission cable 31. In this example, a passenger is able to carry the transportation information display device to attach the transportation information display device on any window of the car to check the speed of the car. For example, the passenger is able to check the speed of the taxi or a bus to remind the driver not to speeding. Likewise, the transportation information display device as shown in FIG. 5 can also be attached to a passenger side of the car, such that the passenger is able to check the speed of the car.

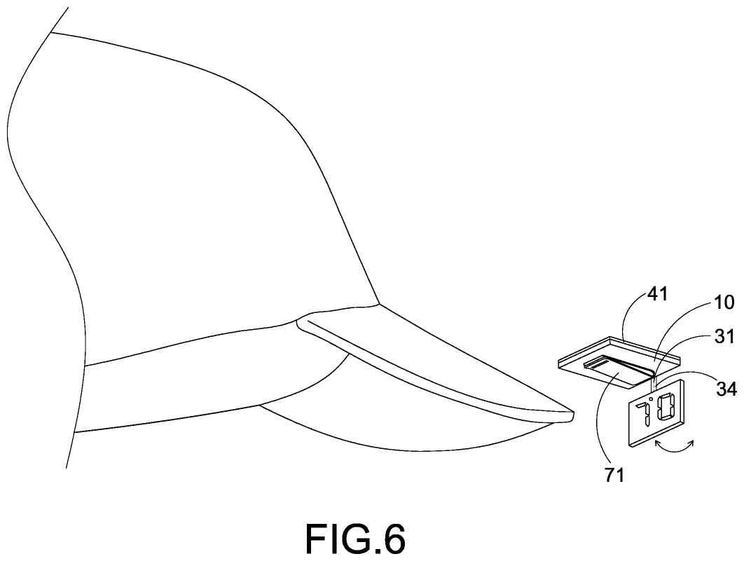

In another example, the transportation information display device is used for a headgear as shown in FIG. 6. As shown in FIG. 6, the transportation information display device can be attached to a hat or a baseball cap. The data transmission link 30 comprises a foldable joint 34 foldably coupling the display unit 20 at the housing 11 of the GPS speedometer 10, such that when the GPS speedometer 10 is stationary fixed at a desire location, the display unit 20 is rotated and pivoted to selectively adjust the viewing angle thereof. In one embodiment, the display unit 20 is coupled at the bottom side of the GPS speedometer 10 via the foldable joint 34, wherein the transmission cable 31 is extended through the foldable joint 34 to electrically connect the GPS module 13 to the display unit 20.

The first attachment 71 is provided at the housing 11 to attach the housing 11 at the brim or visor of the headgear. Preferably, the first attachment 71 can be a clip provided at the housing 11 to detachably clip the housing 11 at the visor, wherein the display unit 20 is selectively rotated and pivotally moved to adjust the position of the display unit 20 so as to selectively adjust a viewing angle of the display unit 20. Accordingly, the power source 40 is received in the housing 11 to electrically power the display unit 20 via the transmission cable 31.

In another example, the transportation information display device is used for a wrist gear as shown in FIG. 7. As shown in FIG. 7, the transportation information display device can be worn by the driver. The foldable joint 34 is foldably coupled between the display unit 20 and the housing 11 of the GPS speedometer 10, such that when the GPS speedometer 10 is stationary fixed at a desire location, the display unit 20 is rotated and pivoted to selectively adjust the viewing angle thereof. In one embodiment, the display unit 20 is coupled at the upper side of the GPS speedometer 10 via the foldable joint 34, wherein the transmission cable 31 is extended through the foldable joint 34 to electrically connect the GPS module 13 to the display unit 20.

The first attachment 71 is provided at the housing 11 to enable the housing 11 being worn by the driver. Preferably, the first attachment 71 can be a wrist band provided at the housing 11 to detachably couple the housing 11 at the wrist of the driver, wherein the display unit 20 is selectively rotated and pivotally moved to adjust the position of the display unit 20 so as to selectively adjust a viewing angle of the display unit 20. Accordingly, the power source 40 is received in the housing 11 to electrically power the display unit 20 via the transmission cable 31.

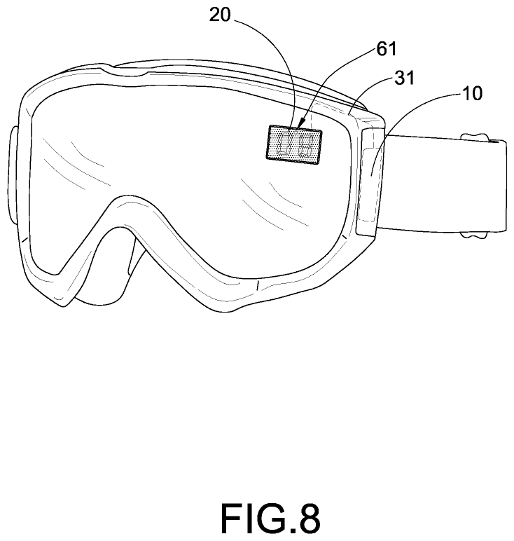

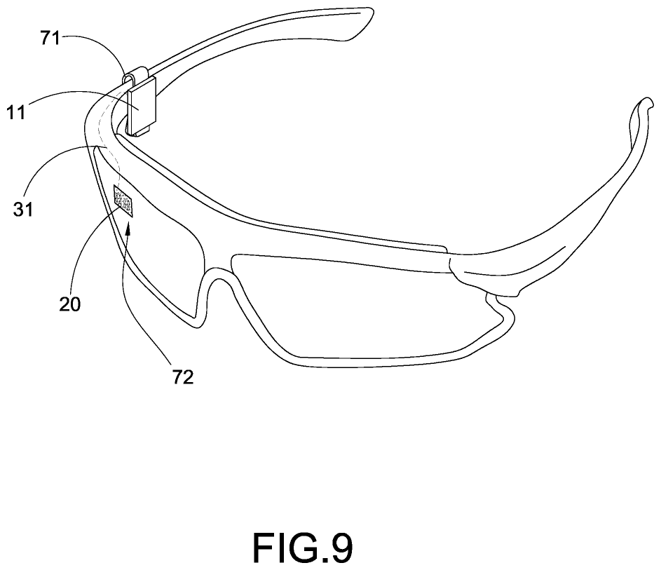

In another example, the transportation information display device is used for an eye gear as shown in FIGS. 8 and 9. As shown in FIG. 8, the transportation information display device can coupled at the first goggle such as a ski goggle or cycling goggle. The housing 11 of the GPS speedometer 10 is built-in with and integrally formed with a spectacle frame while the display unit 20 is provided at an inner surface of a spectacle lens to form an integrated eye gear. Preferably, the display unit 20 is integrally formed at the inner surface of the spectacle lens. The transmission cable 31 is embedded in the spectacle frame to electrically connect the GPS module 13 to the display unit 20. Accordingly, the power source 40 is received in the housing 11 to electrically power the display unit 20 via the transmission cable 31.

FIG. 9 illustrates the transportation information display device coupled at the second goggle such as a bike goggle. The GPS speedometer 10 and the display unit 20 are detachably coupled at different locations of the spectacle. The transmission cable 31 is extended along the spectacle frame to electrically connect the GPS module 13 to the display unit 20. Accordingly, the power source 40 is received in the housing 11 to electrically power the display unit 20 via the transmission cable 31.

The first attachment 71 is provided at the housing 11 to detachably attach the housing 11 at the spectacle frame. The second attachment 72 is provided at the display unit for detachably attaching the display unit 20 onto an inner surface of a spectacle lens. Preferably, the first attachment 71 can be a detachable clip provided at the housing 11 to detachably clip the housing 11 at the spectacle frame. The second attachment 72 can be a self-adhesive film provided at the attaching side of the display unit 20 for adhering the display unit 20 on the inner surface of the spectacle lens. Preferably, the display unit 20 comprises a flexible screen film for displaying the current speed of the vehicle, wherein the self-adhesive film is provided at the flexible screen film for adhering the flexible screen film on inner surface of a spectacle lens.

It is worth mentioning that the transportation information display device can be built-in with the eye wear as shown in FIG. 8 or can be detachably attached to the eye wear as shown in FIG. 9. Furthermore, as it is mentioned above, the display unit 20 can be placed to align with either the dominant eye or non-dominant eye of the user. In other words, the display unit 20 can be placed at either the left lens or the right lens of the eye wear.

The present invention further provides a method of providing a current speed of a vehicle, comprising the steps of:

(1) Place the GPS speedometer 10 at a desired location of an object, such as the motorcycle, car, helmet, headgear, wrist gear and/or eye gear.

(2) Collect the GPS data by the GPS speedometer 10 to generate the current speed signal of the object.

(3) Operatively link the GPS speedometer 10 and the display unit 20 via the data transmission link 30 that the distance between the GPS speedometer 10 and the display unit 20 is adjustable and extendable via the data transmission link 30.

(4) Place the display unit 20 at a position within a user's line of sight, such as the windshield, lens, or via the joint.

(5) Display the current speed signal of the object by the display unit 20 for providing a visualization of the current speed of the object into a visual field of the user within the user's line of sight without requiring the user to remove the visual field away from the road.

Accordingly, all the features in the above preferred embodiments and their alternatives are interchangeable to achieve the objective of the present invention. For example, the wiring configuration and the wireless configuration of the data transmission link 30 can be interchangeably used in different applications. The attachment configurations can be modified to retain the GPS speedometer 10 and the display unit 20 at different locations and/or orientations. Likewise, the configuration of the speed setting module 60 can be interchangeable that the speed setting module 60 can be built-in with the GPS speedometer 10 to integrate with the GPS module 13 with actuating buttons provided at the housing 11 as shown in FIGS. 5 and 7, or can be installed in any portable Internet-able device to remotely control and configure the GPS speedometer 10 as shown in FIG. 2. Therefore, the present invention provides a simple but effective configuration for providing an accurate current speed to the user and for providing a visualization of the current speed of the vehicle into a visual field of a driver within the driver's line of sight without requiring the driver to remove the visual field away from the road.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A transportation information display device for a vehicle, comprising:
a GPS speedometer for obtaining a current speed of the vehicle by computing a current speed of said GPS speedometer which is placed in the vehicle, wherein said GPS speedometer comprises a GPS antenna for receiving GPS signal, and a GPS module serving as a circuit to convert the GPS signal into GPS data and convert the GPS data into a current speed signal of the vehicle;
a display unit adapted for displaying a current speed of the vehicle from said GPS speedometer; and
a data transmission link operatively linking between said GPS speedometer and said display unit to send the current speed signal of the vehicle from said GPS module to said display unit, wherein a distance between said GPS speedometer and said display unit is adjustable and extendable via said data transmission link, such that said display unit is selectively supported at a desired location for providing a visualization of the current speed of the vehicle into a visual field of a driver within the driver's line of sight without requiring the driver to remove said visual field away from the road.

2. The transportation information display device, as recited in claim 1, wherein GPS speedometer further comprises a housing, wherein said GPS antenna is provided at said housing, said GPS module is received in said housing.

3. The transportation information display device, as recited in claim 2, further comprising a power source received in said housing for electrically powering said GPS speedometer and said display unit.

4. The transportation information display device, as recited in claim 2, further comprising a first attachment provided at said housing for attaching said GPS speedometer onto the vehicle, and a second attachment provided at said display unit for attaching said display unit onto a desire location of a windshield of the vehicle.

5. The transportation information display device, as recited in claim 2, wherein said data transmission link comprises a rotatable joint rotatably coupling said display unit at said housing of said GPS speedometer, such that when said GPS speedometer is stationary fixed at a desire location, said display unit is capable of being rotated to selectively adjust a viewing angle thereof.

6. The transportation information display device, as recited in claim 2, wherein said data transmission link comprises a bendable adjusting arm, which is made of bendable material, having one end connected to said housing of said GPS speedometer and another end connected to said display unit, and a transmission cable extended within said bendable adjusting arm to electrically connect said GPS module to said display unit, such that said bendable adjusting arm is selectively bent to adjust a position of said display unit so as to selectively adjust a viewing angle thereof.

7. The transportation information display device, as recited in claim 2, further comprising a headgear attachment provided at said housing for attaching said GPS speedometer at the headgear, wherein said data transmission link comprises a rotatable joint rotatably coupling said display unit at said housing of said GPS speedometer, such that when said GPS speedometer is coupled at the headgear via said headgear attachment, said display unit is capable of being rotated to selectively adjust a viewing angle thereof.

8. The transportation information display device, as recited in claim 2, further comprising a wrist band provided at said housing for attaching said GPS speedometer at a wrist of a user, wherein said data transmission link comprises a foldable joint foldably coupling said display unit at said housing of said GPS speedometer, such that when said GPS speedometer is coupled at the wrist via said wrist band, said display unit is capable of being unfolded to selectively adjust a viewing angle thereof.

9. The transportation information display device, as recited in claim 2, wherein said housing of said GPS speedometer is integrally formed with a spectacle frame while said display unit is provided at an inner surface of a spectacle lens to form an integrated eye gear.

10. The transportation information display device, as recited in claim 2, further comprising a first attachment provided at said housing for attaching said GPS speedometer at a spectacle frame, and a second attachment provided at said display unit for attaching said display unit onto an inner surface of a spectacle lens.

11. The transportation information display device, as recited in claim 1, wherein said data transmission link comprises a transmission cable electrically connecting said GPS speedometer to said display unit.

12. The transportation information display device, as recited in claim 1, wherein said display unit comprises a flexible screen film for displaying the current speed of the vehicle, and a self-adhesive film provided at said flexible screen film for adhering said flexible screen film on a surface.

13. The transportation information display device, as recited in claim 1, further comprising a solar cell electrically connected to said display unit for converting solar energy into electrical energy for said display unit.

14. The transportation information display device, as recited in claim 13, wherein said display unit is wirelessly connected to said GPS speedometer.

15. The transportation information display device, as recited in claim 3, further comprising a photocell switch electrically connected to said power source to automatically switch on and off said GPS speedometer.

16. The transportation information display device, as recited in claim 1, further comprising a speed setting module built-in with said GPS speedometer to operatively link to said display unit, wherein said speed setting module is configured to generate a speed warning signal on said display unit in response to said GPS data.

17. The transportation information display device, as recited in claim 16, wherein said speed setting module comprises a light indicator provided at said display unit for generating said speed warning signal.

18. The transportation information display device, as recited in claim 16, wherein said speed setting module comprises a manual setter operatively connected to said GPS speedometer for manually setting a speed limit to generate said speed warning signal.

19. The transportation information display device, as recited in claim 16, wherein said speed setting module comprises a track mode setter programmed to:
determine a track layout of a racetrack in response to the GPS data;
manually set a maximum speed at each section of the racetrack; and
indicate the maximum speed on said display unit when said GPS speedometer moves at the racetrack.

20. The transportation information display device, as recited in claim 1, wherein said GPS speedometer comprises a recording module recording the current speed of the vehicle in response to said GPS data within a predetermined time interval.
